(19) United States
(12) Patent Application Publication
(10) Pub. No.: US 2016/0216075 A1
(43) Pub. Date: Jul. 28, 2016

(54) GUN-LAUNCHED BALLISTICALLY-STABLE SPINNING LASER-GUIDED MUNITION

(71) Applicant: Raytheon Company, Waltham, MA (US)

(72) Inventor: Nicholas D. Trail, Tucson, AZ (US)

(21) Appl. No.: 14/606,429

(22) Filed: Jan. 27, 2015

(51) Int. Cl. F41G 7/26; G05B 15/02; F42B 5/02

(52) U.S. Cl. CPC F41G 7/26; F42B 5/02; G05B 15/02

(57) ABSTRACT

A gun-launched ballistically-stable spinning laser-guided munition is backward compatible with existing guns with rifled barrels as-deployed for unguided munitions of the same caliber, and will follow the same ballistic trajectory. This allows the laser-guided munitions to be used with the existing base of weapons systems and logistics. The munition comprises a plurality of explosive divert elements arranged around the bullet to produce a force vector through the center of mass (Cm) of the bullet, a SAL guidance system configured to measure a sequence of roll and nod angle pairs (or their equivalent) to the target, a processor configured to process the roll and nod angles to compute a firing solution for one or more of the divert elements to produce a force vector to laterally displace the bullet to drive the nod angle to a prescribed value and a fire controller configured, once its operational mode is initiated, to fire the one or more explosive divert elements according to the firing solution to laterally displace the bullet without affecting the bullet's angle of attack and destabilizing the bullet.

### BACKGROUND OF THE INVENTION

1. Field of the Invention

This invention relates to ballistic munitions, and more particularly to gun-launched ballistically-stable spinning laser-guided munitions.

2. Description of the Related Art

Ballistic projectiles such as gun-launched munitions or tube-launched rockets are projectiles that are briefly powered at launch (e.g. rocket motor burn or blasting powder) and whose trajectory is subsequently governed by the laws of classical mechanics. These projectiles may have an additional rocket motor that is fired mid-course to maintain the ballistic trajectory. A remote control system computes a firing solution for a ballistic trajectory to intercept a target based on the information available at the time. By comparison, non-ballistic projectiles such as cruise missiles are aerodynamically guided in powered flight. If these projectiles lose power to control the forces of drag and lift, then they would follow classical aerodynamic laws and result in a ballistic path, most likely immediately falling to the ground under the influence of gravity.

Gun-launched munitions achieve ballistic stability by spinning at a high rate. The rifling of the gun barrel imparts a spin to the munition when fired. The spin rate must exceed a threshold that is determined by the mass and velocity of the munition. The shorter the length or lower the velocity of the munition the lower the threshold spin rate to achieve stability. These munitions have an angle of attack (AOA) between the munition's axis and the oncoming airflow of nominally zero degrees. The Phalanx close-in weapon system for defense against anti-ship missiles includes a radar-guided 20 mm Gatling gun mounted on a swiveling base. A land based variant, know as C-RAM, has been deployed in a short range missile defense role to counter incoming rockets and artillery fire.

Tube-launched rockets are either spin-stabilized (no spin), slowly spinning (rate of less than a few tens (10s) of Hertz) or de-rolled (control actuation system (CAS) is mounted on a bearing so that although the rocket may spin, the CAS is spin-stabilized). These types of rockets achieve ballistic stability via aerodynamic control surfaces (such as fins, canards or wings). These rockets typically have a non-zero AOA.

These weapon systems are “fire and forget”. The system computes a firing solution based on a ballistic trajectory to intercept the target. The firing solution is based on the best information available about the target (e.g. range, speed, direction), the environment (e.g. temperature, wind conditions etc.) and the projectile itself. The accuracy of such systems is limited by this knowledge and environmental stability.

In certain tube-launched rocket systems, post-launch guidance may be built into the rocket to adjust the trajectory and guide the rocket to the target. Some rockets use GPS and inertial guidance while other use semi-active laser (SAL) guidance to produce a guidance signal. In a SAL system, a laser designator illuminates the target with pulsed laser energy. An optical system and quad-cell detector on the projectile detects the laser spot and produces a guidance signal to remove the error. The CAS uses the guidance signal to control the aerodynamic surfaces to adjust the rocket's AOA and maneuver the rocket to the target. This approach is affective to increase the accuracy of spin-stabilized and slowly spinning rockets that are only marginally ballistically stable. The control surfaces can change the rocket's AOA without destabilizing the rocket.

This approach is not effective for gun-launched munitions. These munitions have a high spin rate, and thus are highly ballistically stable. It is very difficult to change the AOA of such a highly stable munition. Furthermore, if sufficient control force is applied to adjust the AOA it is more likely that the munition will nutate, destabilize, tumble and fall out of its ballistic trajectory. At these high spin rates, the control system simply does not have adequate bandwidth to control the AOA.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a gun-launched ballistically-stable spinning laser-guided munition comprising a bullet and a firing cartridge. The bullet is backward compatible with unguided bullets of the same caliber in that the guided bullet may be fired from existing guns with rifled barrels as-deployed, and will follow the same ballistic trajectory. This allows the guided bullets to be used with the existing base and logistics of weapons systems.

The bullet comprises a plurality of explosive divert elements (e.g., squibs, poppers) arranged around the bullet. Each divert element is configured to produce a force vector (a 1-shot fixed magnitude force vector applied over a brief rotational window) through the center of mass (Cm) of the bullet. The divert elements may be arranged perpendicular to the long axis of the bullet or at an angle thereto. The divert elements may be configured to all produce the same or different force magnitudes.

The bullet includes a semi-active laser (SAL) guidance system that includes an optical system configured to collect and focus reflected pulsed laser energy off of a target and a non-imaging detector (e.g., a quad-cell) configured to detect the focused laser energy and measure a sequence of roll and nod angle pairs (or their equivalent) to the target.

A processor is configured to derive roll and nod angles from one or more pulse measurements. The roll angle provides the direction and the nod angle the magnitude to compute a force vector to laterally displace the bullet to drive the nod angle to a prescribed value. This value may represent a non-zero lead angle initially and then change to a zero angle, or may be held at the calibrated zero angle throughout. The processor is configured to compute based on one or more roll angle measurements and an estimate of the spin rate a firing solution that specifies one or more of the divert elements and firing times to approximate the required force vector to minimize the lateral flight error. The estimate of the spin rate may be derived from a lookup table of spin rate vs. flight time or may be calculated from multiple roll angle measurements which would allow the spin rate and spin rate of change to be determined in-flight. A fire controller is configured, once its operational mode is initiated, to fire the one or more explosive divert elements according to the firing solution to laterally displace the bullet without affecting the bullet's angle of attack and destabilizing the bullet. The processor and fire controller may be configured to implement either a single or iterative firing solutions.

In an embodiment, the bullet has a caliber between 10 mm and 50 mm. Bullets of this caliber are spun up to at least 500 Hz spin rate by the rifling of the gun (and traditionally even above 2,000 Hz upon leaving the barrel).

In different embodiments, the bullet may initiate its operational mode under different criteria. In general, once fired the bullet starts to collect energy and look for a laser spot indicative of a target. The bullet may traverse a substantial portion of its ballistic trajectory based on the initial firing solution of the gun before detecting the target. At this point, the bullet may initiate operational mode immediately or may wait some number of received pulses to gather a measurement history to aid in computation of the firing solution. The bullet may initiate its operational mode based on an estimated time-to-target. A coarse estimate can be made based on the rate of change of the nod angle. A high rate of change, one exceeding a threshold, is indicative of a short time-to-target and the need to initiate the operational mode to divert the bullet. A finer estimate can be based on target data (range, speed, direction) from an external source that is downloaded to the bullet at firing (e.g. an inductive coupling inside the gun platform). The two sources may be fused to further refine the estimate of time-to-target.

In different embodiments, the computed force vector and the firing solution to approximate that force vector may be affected by the specific configuration of the bullet (configuration of explosive divert elements, mode of control, single or multi-pulse, predictive) and estimated time-to-target if available. A so-called “bang/bang” approach determines the direction of the force required to reduce the nod angle and computes a firing solution to approximate that force without concern for the magnitude of the lateral displacement and its cross-range distance at intercept. This approach relies on a high bandwidth and sufficient supply of divert elements to iteratively reduce the nod angle. Another approach uses the estimated time-to-target to configure the firing solution to control the lateral displacement to remove an approximate cross-range distance at intercept. Another approach uses the rate of change of the nod angle in a predictive control loop.

In an embodiment, the guided munition is fired from a weapons system comprising a gun, a laser designator to illuminate the target and a supply of guided munitions. The gun is configured to fire unguided bullets of the same caliber along a ballistic trajectory to intercept a target. The gun may be manually (e.g., a pilot) or automatically (e.g., Phalanx radar) controlled, for example. The laser designator may be slaved to the motion of the gun. In other embodiments, the laser designator may operate independently of the gun. Should the bullet's guidance system be unable to acquire the target, the bullet will follow the initial ballistic trajectory as if it were a normal unguided bullet. In addition, guided munitions can be interspersed with unguided munitions as required by the operation, facilitated by the backwards compatibility and common logistics for operation.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1a and 1b are illustrations of a radar-guided Gatling gun modified to fire SAL-guided bullets;

FIGS. 2a and 2b are of munition altitude and spin-rate versus range and velocity and spin-rate versus time for a M940 (20 mm) bullet following a ballistic trajectory;

FIGS. 3a and 3b are exploded and side views of a SAL-guided bullet and FIG. 3c is a depiction of an explosive divert element;

FIG. 4 is an illustration of the SAL guidance mapping the roll and nod angles from the bullet to the target to spatial displacements of the laser spot on a quad-cell detector;

FIG. 5 is an two-dimensional illustration of the force vector through the Cm of the bullet produced by firing one or more of the explosive divert elements to laterally displace the bullet and drive the nod angle to a prescribed value without affecting the bullet's angle-of-attack or destabilizing the bullet;

FIG. 6 is an illustration of a single-pulse leading to multiple-squib firing solution;

FIG. 7 is an illustration of a dual-pulse signal and squib firing solution; and

FIG. 8 is a flow diagram of an exemplary embodiment for SAL guidance of a ballistically-stable spinning munition fired from a gun platform.

### DETAILED DESCRIPTION OF THE INVENTION

The present invention provides a gun-launched ballistically-stable spinning guided munition comprising a bullet and a firing cartridge. The bullet is backward compatible with unguided bullets of the same caliber in that the guided bullet may be fired from existing guns with rifled barrels as-deployed, and will follow the same ballistic trajectory. This allows the guided bullets to be used with the existing base and logistics of weapons systems such as the Phalanx system or a laser-guided weapons pod for aircraft.

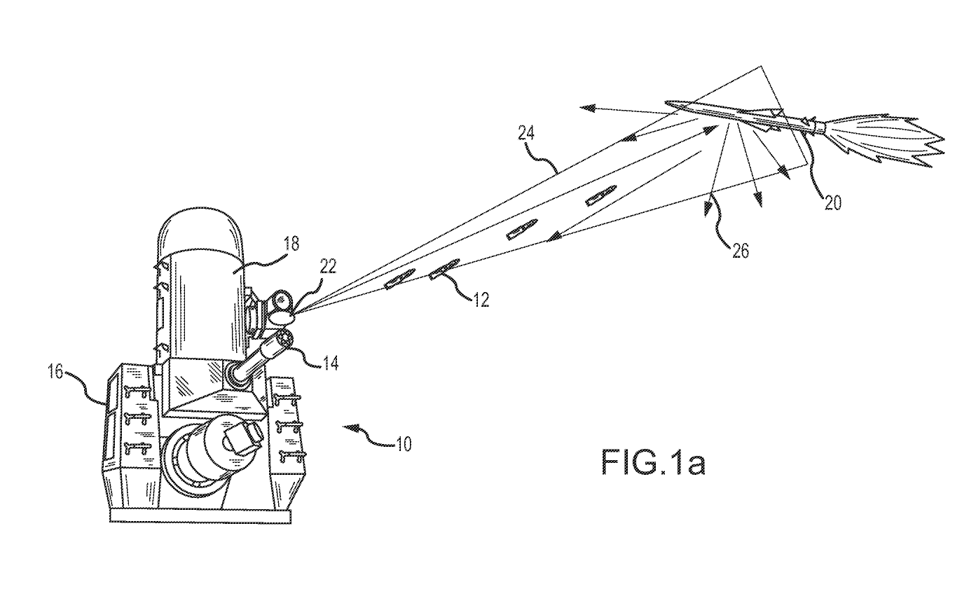

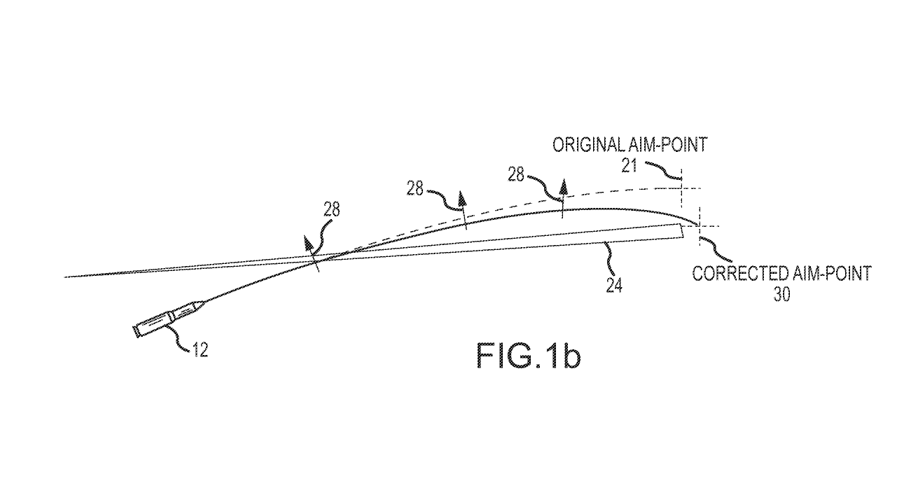

Referring now to FIGS. 1a and 1b, in an embodiment a radar-guided Gatling gun 10 has been adapted to fire laser-guided bullets 12. The Gatling gun includes a gun 14 mounted on a turret 16. A radar system 18 detects and tracks a target 20 to slew the turret and compute a firing solution based on a ballistic trajectory to intercept the target. Gatling gun 10 is designed to fire unguided bullets of the same caliber as the laser-guided bullets 12. The system is supported by the same logistics to track the target and compute the initial firing solution for the ballistic trajectory as it would be for unguided bullets. In fact, guided munitions can be interspersed with unguided munitions as required by the operation, facilitated by the backwards compatibility and common logistics for operation. If the guidance for the laser-guided bullets 12 fails for any reason the bullets default to the ballistic trajectory at an original aim-point 21 the same as an unguided bullet.

To enable laser guidance, the Gatling gun is fitted with a SAL designator 22 that may be co-boresighted with the Gatling gun 14 or offset at a lag angle. As the Gatling gun slews on the turret to track the inbound target, typically at a non-zero lead angle, the SAL designator 22 transmits pulsed laser energy 24 to illuminate target 20.

Each laser-guided bullet 12 comprises a plurality of explosive divert elements (e.g., squibs, poppers) arranged around the bullet to produce a force vector through the center of mass (Cm) of the bullet, a SAL guidance system configured to received reflected laser pulse energy 26 scattered off of target 20 to measure a sequence of roll and nod angle pairs (or their equivalent) to the target, a processor configured to process the roll and nod angles to compute a firing solution for one or more of the divert elements to produce a force vector to laterally displace the bullet to drive the nod angle to a prescribed value and a fire controller configured, once its operational mode is initiated, to fire the one or more explosive divert elements according to the firing solution to produce a force vector 28 that approximates the desired force vector to laterally displace the bullet to a corrected aim-point 30 without affecting the bullet's angle of attack and destabilizing the bullet. The processor and fire controller may be configured to implement either a single or iterative firing solutions.

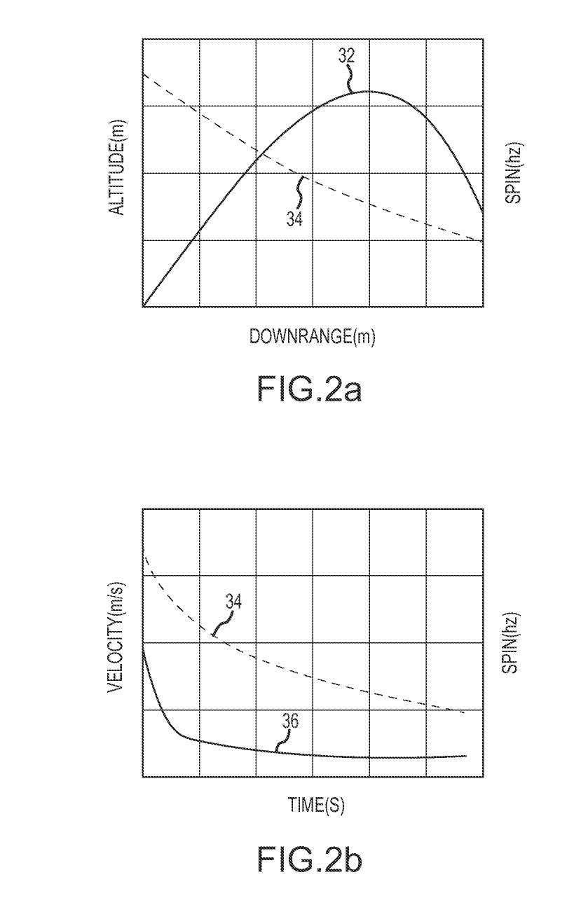

Referring now to FIGS. 2a and 2b, a ballistic trajectory for an unguided or laser-guided bullet is governed by the laws of classical mechanics. The bullet's altitude in this trajectory 32 is parabolic nature. The bullet's spin-rate 34 and velocity 36 peak at firing and decrease with time and range. The altitude, spin-rate and velocity are well-characterized given the known physical properties of the bullet and its initial trajectory, velocity and spin-rate when exiting the gun. Except for a possible minor deviation in altitude due to the lateral displacement from firing the divert elements, the laser-guided bullet is governed by the same laws of classical mechanics and exhibits the same ballistic characteristics. The guidance command is corrects for external forces (cross-wind, pressure/temperature changes), aiming error, target vector displacement, etc. . . . with a typical correction on the order of 1 to 100 meters.

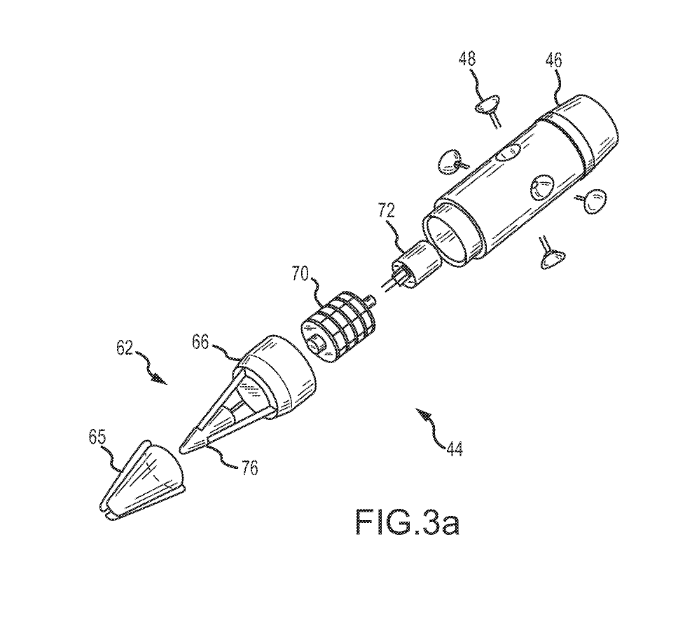

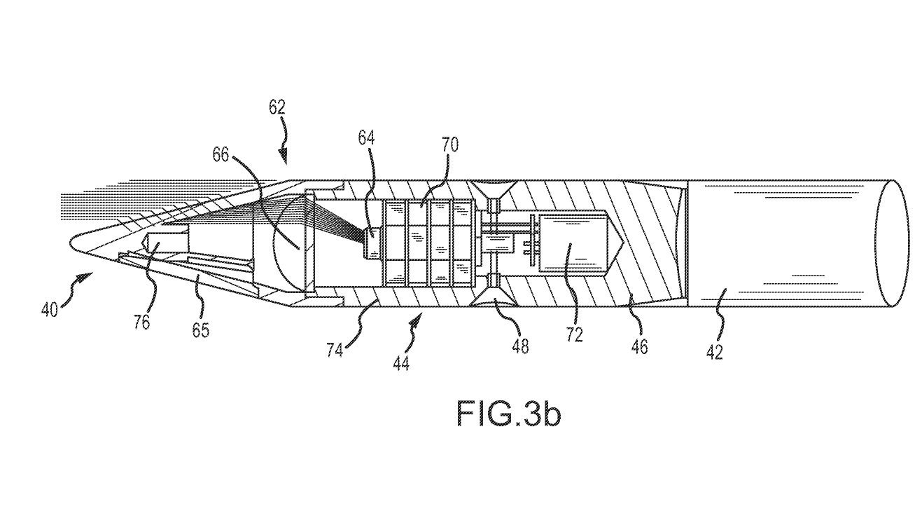

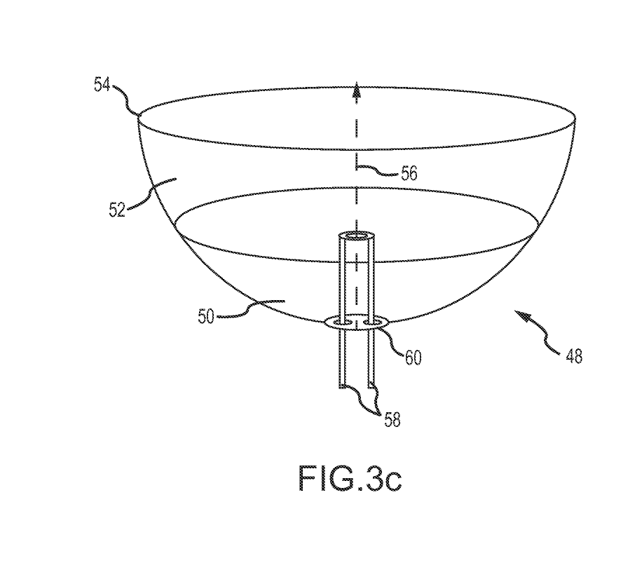

Referring now to FIGS. 3a, 3b and 3c, an embodiment of a laser-guided bullet 40 comprises a firing cartridge 42 including a fast burning propellant such as gun powder and a bullet 44. The bullet may have a caliber between 10 mm and 50 mm and a spin rate of at least 500 Hz. Bullet 44 comprises a shell casing 46 and a plurality of explosive divert elements 48 arranged around the casing. Each explosive divert element is configured to produce a force vector through the center of mass (Cm) of the bullet. The force vector is a 1-shot fixed magnitude force applied over a brief rotational window of the spinning bullet through the center of mass (Cm) of the bullet. The divert elements may be arranged perpendicular to the long axis of the bullet or at an angle thereto. The divert elements may be angled in order that they may be combined to produce certain force vectors or to package them in limited space. The divert elements may be configured to all produce the same or different force magnitudes. An exemplary explosive divert element 48 includes a ceramic plug 50, a main charge 52 such as BNCP or ZPP and a closure disc 54 that fill a conical or parabolic volume that is symmetric about an axis 56. Ignition pins 58 penetrate the volume through a glass-to-metal seal 60 into the main charge 52. An electrical pulse applied to the pins ignites the main charge whose detonation produce a force vector along the Cm axis 56 with a fixed magnitude.

The bullet is provided with a SAL guidance system that includes an optical 62 system configured to collect and focus reflected pulsed laser energy off of a target and a non-imaging detector 64 (e.g., a silicon or InGaAs quad-cell) configured to detect the focused laser energy and measure a sequence of roll and nod angle (or their equivalent) pairs to the target. Optical system 62 includes a conformal window 65 that is substantially transparent to the spectral band of the laser (approximately 1.05 to 1.6 microns) and a lens(es) 66 that collect and focus the laser energy. The lens(es) 66 may comprise standard geometric lenses or a lenslet array.

Electronics 70 include a processor(s) configured to compute based on the nod angle from one or more angle pairs a force vector to drive the nod angle to a prescribed value. This value may represent a non-zero lead angle initially and then change to a zero angle, or may be held at a calibrated zero angle throughout. The processor is configured to compute based on one or more roll angle measurements and an estimate of the spin rate a firing solution that specifies one or more of the divert elements and firing times to approximate the required force vector to minimize the lateral flight error. The estimate of the spin rate may be derived from a lookup table of spin rate vs. flight time or may be calculated from multiple roll angle measurements that allows an estimate of the spin rate of change to be determined. Electronics 70 include a fire controller configured to produce the ignition pulses to fire the one or more of explosive divert elements according to the firing solution to laterally displace the bullet without affecting the bullet's angle of attack and destabilizing the bullet. A power source 72 such as a long-life (chemical) battery or a (super) capacitor charged via inductive coupling at firing is used to power the detector and electronics.

In different embodiments, the bullet may initiate its operational mode under different criteria. In general, once fired the bullet starts to collect energy and look for a laser spot indicative of a target. The bullet may traverse a substantial portion of its ballistic trajectory based on the initial firing solution of the gun before detecting the target. At this point, the bullet may initiate the operational mode immediately or may wait some number of received pulses to gather a measurement history to aid in computation of the firing solution. The bullet may initiate its operational mode based on an estimated time-to-target. A coarse estimate can be made based on the rate of change of the nod angle. A high rate of change, one exceeding a threshold, is indicative of a short time-to-target and the need to initiate the operational mode to divert the bullet. A finer estimate can be based on target data (range, speed, direction) from an external source that is downloaded to the bullet at firing (e.g. an inductive coupling inside the gun barrel or platform). The two sources may be fused to further refine the estimate of time-to-target.

To facilitate inductive coupling for power and data transfer, an inductive coil 74 is formed inside the bullet casing and coupled to the electronics and power source. The induction coil is configured to produce a current in response to passing through an external magnetic field in or near the gun platform. The current comprises a DC term to charge a power supply to power the bullet and an AC term that includes target information being passed to the bullet to compute the firing solution.

In different embodiments, the computed force vector and the firing solution to approximate that force vector may be affected by the specific configuration of the bullet (configuration of explosive divert elements, mode of control, single or multi-pulse, predictive) and estimated time-to-target if available. A so-called “bang/bang” approach determines the direction of the force required to reduce the nod angle and computes a firing solution to approximate that force without concern for the magnitude of the lateral displacement and its cross-range distance at intercept. This approach relies on a high bandwidth and sufficient supply of divert elements to iteratively reduce the nod angle. Another approach uses the estimated time-to-target to configure the firing solution to control the lateral displacement to remove an approximate cross-range distance at intercept. Another approach uses the rate of change of the nod angle in a predictive control loop.

In this embodiment, the bullet also includes a counter-weight/impact mass 76. The impact mass serves to improve the lethality of the bullet upon impact, by allowing the impact tip to be harder or stronger metal, or include features to increase the resulting impact pressure to improve penetration. In addition, this mass feature and location allows a deterministic approach to adjust the center of mass (Cm) location in any given bullet, by removing/adding small metal quantity on any individual bullet. This aids the bullet behavior by ensuring the Cm location is within a prescribed tolerance zone at the divert/squib axis location(s).

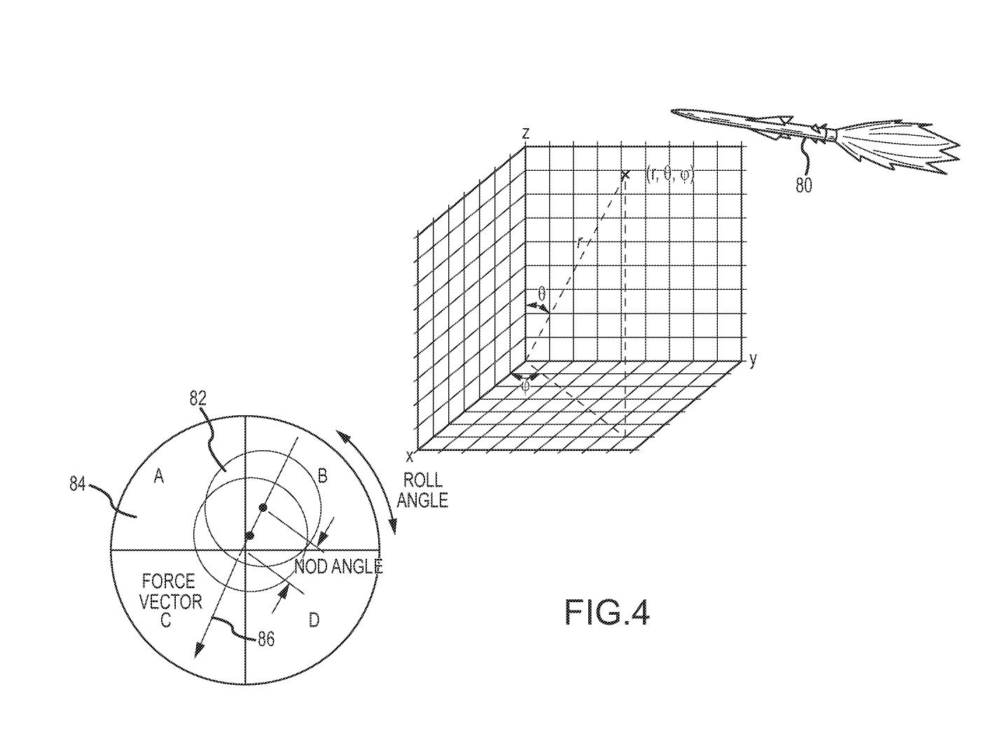

Referring now to FIG. 4, the SAL optical system converts the angles (roll φ and nod θ) between the bullet and a target 80 to a spatial displacement of the laser spot 82 in the plane of the quad-cell detector 84. The optical axis of the bullet is oriented along the positive Z-axis. The roll angle φ is decoded as the rotation of the center of the laser spot around the center of the detector. The nod angle θ is decoded as the distance from the center of the detector to the center of the laser spot. The desired force vector 86 (direction=roll, and magnitude=nod) is computed to cancel the measured roll/nod values on the detector. A single roll/nod measurement may have considerable error. The SNR can be improved by processing multiple roll/nod measurements. Furthermore, the limited number of discrete divert elements may not be able to produce the exact magnitude of the desired force vector. Therefore an iterative solution of measuring the roll/nod angle, firing one or more divert elements to remove lateral flight error and repeating may be preferred.

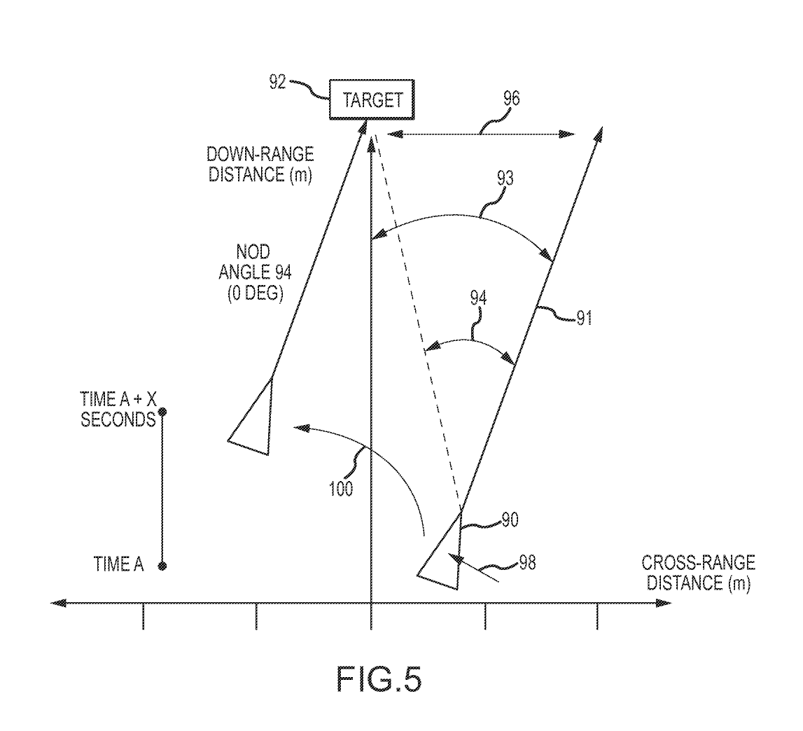

Referring now to FIG. 5, assuming for simplicity a zero lead-angle between a bullet 90's flight path 91 and a target 92, as shown at Time A bullet 90 having an AOA 93 of zero degrees has a non-zero Nod Angle 94 to the target that translates to a cross-range error 96. Firing of one or more divert elements to produce a force vector 98 through the bullet's Cm over a rotational window of X seconds produces a lateral displacement 100 of the bullet that drives the Nod Angle 94 to zero degrees ideally and eliminates the cross-range error without changing the bullet's AOA and destabilizing its flight path.

For a single divert maneuver to completely eliminate the cross-range error, all of the computed and produced force vector and the timing of the divert maneuver must be perfect, which is extremely unlikely. However, perfection is not the goal of the laser-guidance of the bullet. The goal is to reduce the error and to increase the probability that the bullet will intercept the target along the ballistic trajectory with minor course modifications. Based on time-to-target once the target is acquired and the divert capability of the explosive divert elements, the cross-range displacement is typically less than 100 meters, which is sufficient for the missions performed by these types of guns.

The accuracy of the desired force vector can be improved in a number of ways. First, the electronics can process multiple pulse measurements to reduce noise. Second, the electronics can compute the rate of change of the nod angle measurement to predict nod angle measurements (assuming no further divert maneuvers) and use that prediction to compute the desired force vector. For example, the current nod angle estimate may be 1 degree. Absent the rate of change information a divert maneuver to remove the 1 degree nod may be computed and executed. However, if the rate of change information indicated that the nod angle was trending towards zero, a smaller divert maneuver or no divert maneuver may be executed.

The firing solution to approximate the desired force vector similarly has a number of variables. The system must produce both the roll angle (timing of ignition of the divert elements) and the magnitude (force produced by the ignited elements). The accuracy of the ignition timing depends on both the accuracy of the roll angle measurement and the accuracy of the current spin rate of the bullet. Processing of multiple pulse measurements will reduce the noise of the roll angle. The current spin-rate can be estimated in different ways. For a given bullet and gun, the spin-rate of the bullet as it exits the gun barrel can be estimated and stored in the bullet electronics fairly accurately. As shown in FIG. 2a, a LUT of spin-rate vs flight time can also be stored. By tracking a clock signal in the electronics, an estimate of the current spin rate is available. Now this estimate is based on the statistics of many bullets and firings, not on the actual spin rate of the current bullet at the current time. Alternately, the spin-rate can be estimated directly from the roll angle measurements. Essentially, the difference between two consequent roll angle measurements (known, fixed time delta) provides an estimate of the spin rate.

The magnitude of the force vector produced by the ignition of the explosive divert elements can be controlled in a number of ways. First, the bullet may be provided with explosive divert elements with different explosive charges to produce force vectors with different magnitudes. Second, the firing solution may be computed to ignite multiple divert elements to increase or decrease the effective magnitude of the force vector.

The timing of the divert maneuver greatly affects both the lateral displacement produced by a given force vector and the resultant cross-range distance at target intercept. The lateral displacement produced by a given force vector depends on the velocity of the bullet. The higher the velocity the more ballistically stable the bullet, hence the harder it is to displace the bullet. The same force applied to a bullet later in flight (at a slower velocity) will laterally displace the bullet further than the force applied early in flight at a higher velocity. However, the same lateral displacement produced earlier in flight will have a greater effect on cross-range distance at target intercept.

The issue is that based solely on the roll/nod angle measurements, the bullet does not know the range or time-to-target intercept. This is one reason that the goal of the laser-guidance system is to reduce, not eliminate all error, and that the preferred implantation is iterative such that the bullet can continually gather guidance information and perform divert maneuvers to reduce the lateral error until intercept.

Acknowledging these limitations, there are different approaches to initiate the operational mode to start performing the divert maneuvers. A first approach is to simply wait a fixed period after the bullet starts to detect target pulses. This can be based on apriori knowledge of the gun and bullets and the expected threat. A second approach is monitor the rate of change of the nod angle. If the rate of change is low, indicating a stable nod angle, the time-to-target is relatively long. As the bullet gets close to the target the lead angle of the bullet should rapidly change from its non-zero value towards zero. Once the rate of change exceeds a threshold the bullet can initiate its operational mode. Another approach is to use inductive coupling between the gun and the bullet to download the most up to date target information, from the radar tracking system for example, into the bullet as it is fired. The current range, speed and direction of the target plus environmental factors such as wind speed and direction can be downloaded to the bullet. This information, perhaps augmented by the measured rate of change of the nod angle, can be used to initiate the operational mode such that the lateral displacement of the bullet can more accurately remove the cross-range error at target intercept.

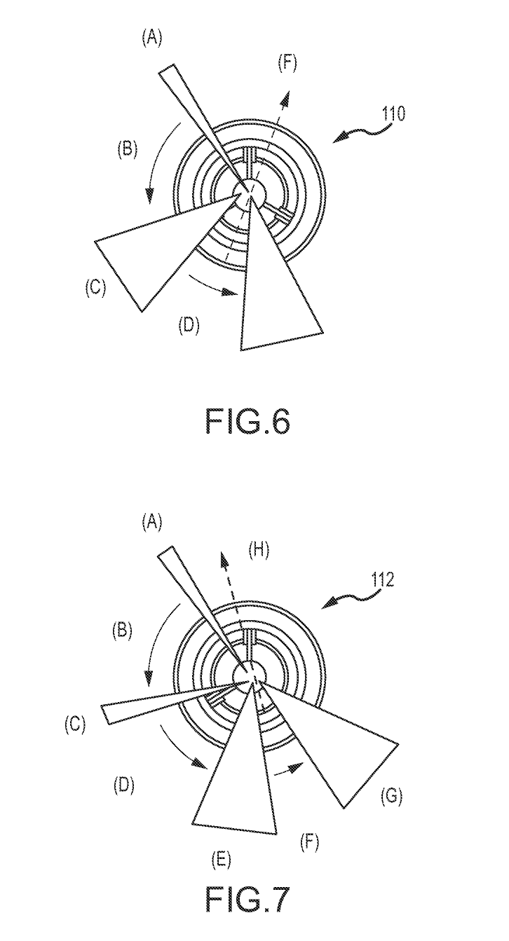

Referring now to FIG. 6, an embodiment of a “single-pulse” firing solution is depicted. A bullet 110 rotates at its natural frequency, for example, between 1-2 KHz for a 20 mm round. During any rotational period,
(A) Upon laser signal detection, the guidance system captures the angular alignment of the signal on the quad-cell detector,
(B) System counts down the microseconds that equate to the angular offset of the received signal and then triggers the first explosive divert element,
(C) Captures the rotational window for the divert element operation and net vector angle,
(D) (Optional) The system can wait another specified time-constant to trigger a second divert element to create a net vector of displacement or balance forces,
(E) (Optional) Captured window for second squib operation, and
(F) Net Vector Displacement for bullet lateral movement from initiation of the as-shown two (2) squib events.

This can be achieved though either an angular rate sensor (most likely a high-rate MEMS device) that measures the spin-rate, or after correlating the spin-down rate through the dual-pulse approach (where the time constant between the two ˜20 nsec pulses are known, and can be approximately 100 microseconds).

Referring now to FIG. 7, an embodiment of a “dual-pulse” firing solution is depicted. A bullet 120 rotates at its natural frequency, for example, between 1-2 KHz for a 20 mm round. During any rotational period,
(A) Upon laser signal detection, the guidance system captures the angular alignment of the signal on the quad-cell detector,
(B) System electronics are reset for anticipated second signal detection, and counts the microseconds since first detection peak,
(C) Captures the second laser signal detection and associated angular alignment relative to the quad-cell detector and correlates to spin-rate and spin-rate of change (if other pulse history is available),
(D) System counts down the microseconds that equate to the angular offset of the received signal and then triggers the first divert element,
(E) Captures the rotational window for the divert element operation and net vector angle,
(F) (Optional) The system can wait another specified time-constant to trigger a second divert element to create a net vector of displacement or balance forces,
(G) (Optional) Captured window for second squib operation, and
(H) Net Vector Displacement for bullet lateral movement from initiation of the as-shown two (2) squib events.

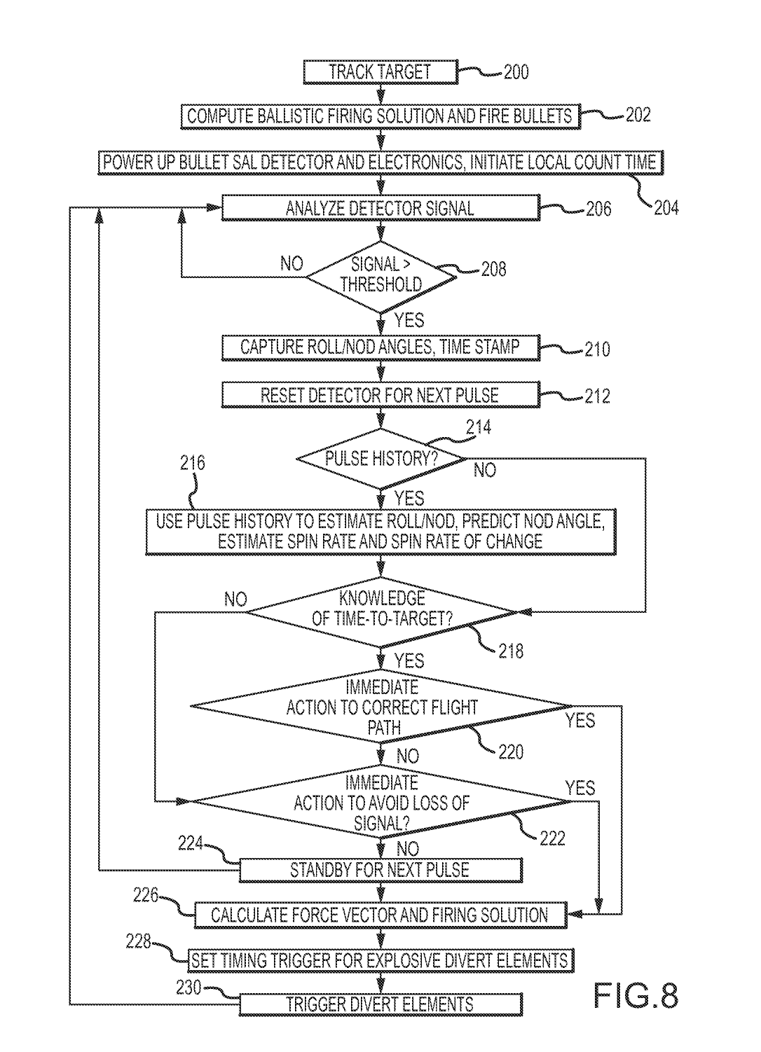

Referring now to FIG. 8, in an embodiment of an engagement of a target by a gun configured to fire laser-guided bullets the gun tracks the target (step 200), computes a ballistic firing solution to intercept the target and fires a laser-guided bullet (or bullets) at the target (step 202). The laser designator is aimed either dependently (slaved to the motion of the gun) or independently at the target.

Upon firing, the power source is activated and the electronics/detector are powered on (within first fraction of second) and local count time is initiated (step 204), (with any programmed offset to predict total flight time). The detector signal is analyzed (step 206) and if a signal of interest (e.g. a laser spot) is detected it is compared to a threshold (step 208). This repeats until a target signal is detected.

The roll/nod angles are captured from the signal and time stamped (step 210). The detector is reset for the next pulse (step 212). If a pulse history is available (step 214), the history is used to improve the roll/nod angle estimates, predict the nod angle and estimate the spin-rate and rate of change of the spin-rate (step 216). If not, control passes directly to step 218 to determine whether knowledge of the time-to-target exists, either from a coarse estimate of the rate of change of the nod angle or from external information downloaded to the bullet. If such knowledge exists, the system determines whether immediate action to correct the flight path is required given the remaining time-to-target (step 220). If such knowledge does not exists but exists and does not require immediate action, the system determines whether immediate action to correct the flight path is required to avoid loss of signal (e.g., is the laser spot moving outside the linear region of the quad-cell detector) (step 222).

If immediate action is not required, the system stands by for a next pulse (step 224) and returns to step 206 to analyze the detector signal. If immediate action is required, the system calculates the force vector and firing solution (step 226) and sets the timing trigger for the selected explosive divert elements (step 228). Equivalently the system could calculate the force vector and firing solution in step 226 for all detected pulses and only set the timing triggers once immediate action was required. The system triggers the divert elements (step 230) to produce a force vector through the Cm of the bullet to laterally displace the bullet and reduce lateral flight error.

Control returns to step 206 to analyze the detector signal and repeat the process to iteratively reduce the nod error until the bullet intercepts the target.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A gun-launched ballistically-stable spinning laser-guided munition, comprising:
a firing cartridge including a propellant; and
a bullet mounted forward of the firing cartridge, said bullet comprising:
a plurality of explosive divert elements arranged around the bullet, each divert element configured to produce a force vector through the center of mass (Cm) of the bullet;
an optical system configured to collect and focus reflected pulsed laser energy off of a target;
a non-imaging detector configured to detect the focused laser energy and measure a sequence of roll and nod angle pairs to the target;
a processor configured to compute based on the nod and roll angles from one or more angle pairs a force vector to laterally displace the bullet and drive the nod angle to a prescribed value and based on the roll angle from the one or more angle pairs and an estimate of the spin rate to compute a firing solution that specifies one or more of the divert elements and firing times to approximate force vector; and
a fire controller configured to fire the one or more of explosive divert elements according to the firing solution to laterally displace the bullet without affecting the bullet's angle of attack and destabilizing the bullet.

2. The laser-guided munition of claim 1, wherein the bullet has a caliber between 10 mm and 50 mm and a spin rate of at least 500 Hz.

3. The laser-guided munition of claim 1, wherein each said explosive divert element is configured to produce a single fixed force vector over a rotational window.

4. The laser-guided munition of claim 1, wherein the non-imaging detector comprises a quad-cell detector.

5. The laser-guided munition of claim 1, wherein the processor is configured to process a single received pulse to compute the firing solution.

6. The laser-guided munition of claim 1, wherein the processor is configured to process multiple received pulses to compute the firing solution.

7. The laser-guided munition of claim 6, wherein the processor is configured to compute the estimate of the spin rate and change in spin rate from the sequence of roll angles for the multiple received pulses.

8. The laser-guided munition of claim 6, wherein the processor is configured to estimate a rate of change of the nod angle from the multiple received pulses to predict a nod angle and compute the force vector.

9. The laser-guided munition of claim 6, wherein the processor is configured to compute a rate of change of the nod angle from the multiple received pulses as a coarse estimate of time-to-target when the rate of change exceeds a threshold to trigger the fire controller to enter an operational mode to execute the firing solution.

10. The laser-guided munition of claim 1, wherein the processor and fire controller are configured to implement multiple firing solutions to iteratively drive the nod angle to the prescribed value.

11. The laser-guided munition of claim 1, wherein the processor and fire controller are configured to implement at least one firing solution to drive the nod angle to a non-zero lead angle and to then implement at least one firing solution to drive the nod angle to zero.

12. The laser-guided munition of claim 1, wherein the bullet further comprises an induction coil configured to produce a current in response to passing through an external magnetic field in or near the gun platform, said current comprising a DC term to charge a power supply to power the bullet and an AC term that includes target information passed to the munition to compute the firing solution.

13. The laser-guided munition of claim 1, wherein the bullet is configured to follow an initial ballistic trajectory absent the firing of any of the explosive divert elements.

14. A weapons system, comprising:
a gun, said gun configured to fire unguided bullets of a certain caliber along a ballistic trajectory to intercept a target;
a laser designator configured to transmit pulsed laser energy to illuminate the target;
a plurality of laser-guided bullets of said certain caliber, each said bullet comprising;
a plurality of explosive divert elements arranged around the bullet, each divert element configured to produce a force vector through the center of mass (Cm) of the bullet;
an optical system configured to collect and focus reflected pulsed laser energy off of the target;
a non-imaging detector configured to detect the focused laser energy and measure a sequence of roll and nod angle pairs to the target;
a processor configured to compute based on the roll and nod angles from one or more angle pairs a force vector to laterally displace the bullet and drive the nod angle to a prescribed value and based on the roll angle from the one or more angle pairs and an estimate of the spin rate to compute a firing solution that specifies one or more of the divert elements and firing times to approximate the force vector; and
a fire controller configured to fire the one or more of explosive divert elements according to the firing solution to laterally displace the bullet without affecting the bullet's angle of attack and destabilizing the bullet.

15. A method of guiding a ballistically-stable spinning bullet, comprising:
firing a laser-guided bullet from a gun along a ballistic trajectory to intercept a target, said gun configured to fire unguided bullets of the same caliber along the ballistic trajectory and to impart a spin rate of at least 500 Hz to the bullets;
transmitting pulsed laser energy to illuminate the target;
collecting and focusing reflected pulsed laser energy on the bullet;
detecting the focused laser energy to measure a sequence of roll and nod angle pairs to the target;
computing based on the roll and nod angles from one or more angle pairs a force vector to laterally displace the bullet and drive the nod angle to a prescribed value;
computing based on the roll angle from the one or more angle pairs and an estimate of the spin rate a firing solution that specifies one or more of a plurality of explosive divert elements arranged around the guided bullet and firing times to approximate the force vector; and
firing the one or more of explosive divert elements according to the firing solution to laterally displace the bullet without affecting the bullet's angle of attack and destabilizing the bullet.

17. The method of claim 16, further comprising computing the estimate of the spin rate from the sequence of roll angles for the multiple received pulses.

18. The method of claim 16, further comprising estimating a rate of change of the nod angle from the multiple received pulses to predict a nod angle and compute the force vector.

19. The method of claim 16, further comprising estimating a rate of change of the nod angle from the multiple received pulses as a coarse estimate of time-to-target and when the rate of change exceeds a threshold triggering the fire controller to enter an operational mode to execute the firing solution.

20. The method of claim 16, further comprising inductively coupling an external magnetic field in or near the gun platform to induce an electrical current in an inductive coil in the bullet, said current comprising a DC term to charge a power supply to power the bullet and an AC term that includes target information passed to the munition to compute the firing solution.
